(19) United States
(12) Patent Application Publication
(10) Pub. No.: US 2012/0094775 A1
(43) Pub. Date: Apr. 19, 2012

(54) UNIVERSAL JOINT MECHANISM

(76) Inventors: Majid Yaghoubi, Qazvin (IR); Sayed Saeid Mohtasebi, Qazvin (IR); Ali Jafari, Qazvin (IR)

(21) Appl. No.: 12/906,160

(22) Filed: Oct. 18, 2010

(51) Int. Cl. F16D 3/16

(52) U.S. Cl. 464/147

(57) ABSTRACT

The various embodiments herein provide a constant speed universal mechanical joint mechanism with crossover angle up to 90 degrees and more. The universal mechanical joint comprises an input coupling, an output coupling, at least one input shaft, at least one output shaft, a plurality of guide arms, at least three connecting arms, a plurality of connecting means, a plurality of external retaining rings and a plurality of bearings. The input coupling is connected to the input shaft and the output coupling is connected to the output shaft in such a way that the plurality of retaining rings joins each of the input coupling and the output coupling with the plurality of guide arms and the plurality of connecting means. The plurality of retaining rings and the plurality of bearings are used to connect each of the plurality of guide arms to the at least three connecting arms.

### BACKGROUND

1. Technical Field

The embodiments herein generally relates to universal mechanical joints and particularly to a constant speed universal mechanical joints used in torque transmission with crossover angle up to 90 degrees and more.

2. Description of the Related Art

Generally constant velocity mechanical joint such as universal joints are used in power transmission systems in automobiles and various industrial machines. The universal joint connects a rotating shaft on a driving side to a rotating shaft on a driven side so as to transmit a torque at constant angular velocity. The constant velocity universal joint includes a fixed type joint and a plunging type joint. While the fixed type joint allows only angular displacement, the plunging type joint allows both the angular displacement and the axial displacement.

Currently, several mechanical, pneumatic, hydraulic, and magnetic mechanisms are used in transmitting power between two crossover shafts. However, the mechanical type universal joint is used in the industry due to its low manufacturing cost.

Hooke joint is one type of universal joint which is commonly used and is categorized into two types, such as the cardan joint and the spherical joint. The cardan joint and the spherical joint have relative crossover angles of 15 and 45 degrees, respectively. However, the angular velocity of the driven shaft of these joints is not constant. This means that the ratio of an output velocity to an input velocity is not equal at all angles of rotation. Moreover these mechanisms have restricted crossover angle and also many of these Hooke joints take up more space to fit in.

Hence there is a need for a universal mechanical joint mechanism which can be used between two shafts with cross over angle greater than 90 degrees. There also exists a need for a universal mechanical joint mechanism with dynamically balanced universal mechanical joint occupying an optimum working space. Furthermore there exists a need for a universal mechanical joint mechanism with constant velocity ratio for all crossover angles between the shafts.

The abovementioned shortcomings, disadvantages and problems are addressed herein and which will be understood by reading and studying the following specification.

### OBJECTIVE OF THE EMBODIMENTS

The primary object of the embodiments herein is to provide a constant speed universal mechanical joint which can be used between two shafts.

Another object of the embodiments herein is to provide a constant speed universal mechanical joint with a cross over angle up to 90 degrees and more.

Yet another object of the embodiments herein is to provide a constant speed universal mechanical joint mechanism in which a mechanical universal joint is dynamically balanced between the two shafts.

Yet another object of the embodiments herein is to provide a constant speed universal mechanical joint mechanism in which the mechanical joint occupies an optimum space between the two shafts.

Yet another object of the embodiments herein is to provide a constant speed universal mechanical joint with a constant input velocity ratio is for all crossover angles between the shafts.

These and other objects and advantages of the embodiments herein will become readily apparent from the following detailed description taken in conjunction with the accompanying drawings.

### SUMMARY

The various embodiments herein provide a universal mechanical joint mechanism comprising an input coupling, an output coupling, at least one input shaft, at least one output shaft, a plurality of guide arms, at least three connecting arms, a plurality of connecting means, a plurality of external retaining rings and a plurality of bearings. The input coupling is connected to the input shaft and the output coupling is connected to the output shaft in such a way that the plurality of retaining rings joins each of the input coupling and the output coupling with the plurality of guide arms through the plurality of connecting means. The plurality of retaining rings and the plurality of bearings connect each of the plurality of guide arms to the at least three connecting arms.

According to an embodiment herein, the plurality of guide arms includes at least three primary guide arms and at least three secondary guide arms. The plurality of guide arms is at least one of a L shaped structure or C-shaped structure with at least two openings to join at least one of the input coupling, output coupling and one of the at least three connecting arms.

According to an embodiment herein, the universal mechanical joint mechanism comprises of at least five cylindrical and at least nine revolute joints fastened to the plurality of guide arms. The input coupling and the output coupling includes at least three Y′ shaped branches wherein the angle between each of the at least three ‘Y’ shaped branches is 120 degrees and at least three Y′ shaped branches is formed in a shape of a straight angle, C-shape or a sector of sphere.

According to an embodiment herein, at least three connecting arms of the universal mechanical joint mechanism is formed in a shape of a straight, angled, curved, triangular or a sector of sphere. The at least one primary guide arm, at least one secondary guide arm and at least one connecting arm is connected to at least one branch of the input coupling and the output coupling.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates an isometric view of the constant speed universal mechanical joint used between two shafts with a crossover angles up to 135 degrees according to an embodiment herein.

FIG. 2 illustrates an isometric view of the constant speed universal mechanical joint and its components at 130 degree crossover angle according to an embodiment herein.

FIG. 3 illustrates an isometric view of the constant speed universal mechanical joint used between two shafts according to an embodiment herein.

FIG. 4 illustrates an exploded view of the primary components used in the fabrication mechanism of the constant speed universal mechanical joint according to an embodiment herein.

FIG. 5 illustrates a perspective view of the constant speed universal mechanical joint indicating that the symmetry is preserved in the plane at all angles according to an embodiment of the present disclosure.

FIG. 6 illustrates graphs indicating the relationship of an angular velocity with respect to time and different orientations of the constant speed universal mechanical joint according to an embodiment herein.

FIG. 7 illustrates a graph indicating the relationship between the angular velocity and angular displacement of the constant speed universal mechanical joint according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a universal mechanical joint which provides a constant output speed at all crossover angles. The universal mechanical joint connects a rotating shaft on a driving side to a rotating shaft on a driven side so as to transmit torque at constant angular velocity.

According to an embodiment herein, the universal joint mechanism comprises of an input shaft, an output shaft, an input coupling, an output coupling, at least three guided arms called as primary guide arms connecting the input coupling, at least three guided arms called as secondary guide arms connecting the output coupling and at least three connecting arms connecting the guided arms at the input coupling and the guided arms at the output coupling.

Each of the input couplings and the output couplings are connected to the guide arms by at least three retaining rings externally and each of the guide arms are connected to the connecting arms by the pins, the bearings and retaining rings externally.

The rotary motion is transmitted from the input shaft to the input coupling. The input coupling transmits the rotary motion to the primary guide arms which transmits through the connecting arms, secondary guide arms, output coupling and finally to output shaft. Thus the univeral joint mechanism with aforementioned configuration is arranged between two shafts to obtain a constant speed with crossover angles up to 135 degrees.

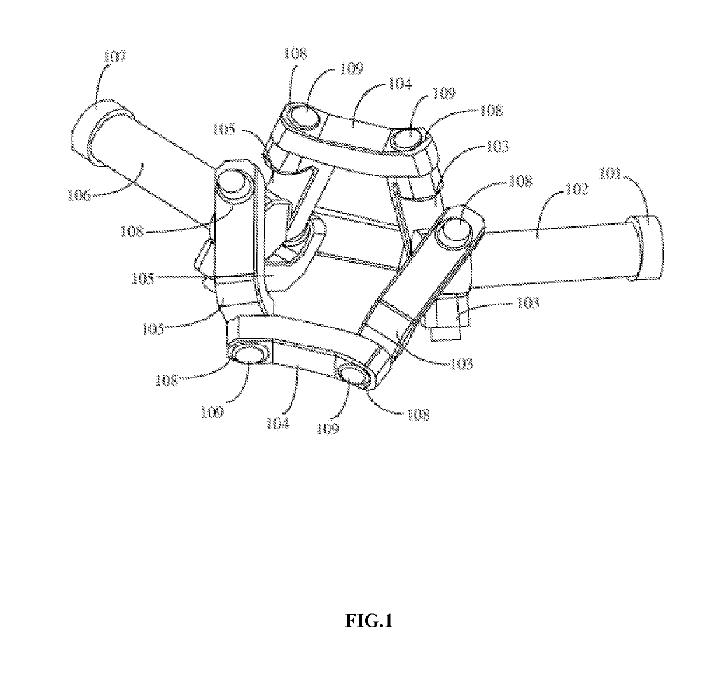

FIG. 1 illustrates an isometric view of the constant speed universal mechanical joint arranged between two shafts with a crossover angles up to 135 degrees according to an embodiment herein. The constant speed universal mechanical joint is dynamically balanced and occupies optimum working space. Its velocity ratio is constant for all crossover angles between the two shafts. The mechanism comprises of an input shaft 101, an input coupling 102, an output shaft 107, an output coupling 106, at least three primary guide arms 103, at least three secondary guide arms 105, at least three connecting arms 104, at least six pins 109, at least eighteen retaining ring externally 108 and at least twelve bushes or bearings 110. The input coupling 102 and the output coupling 106 are coupled to the input shaft 101 and to the output shaft 107 respectively. The input coupling 102 is fastened to at least three primary guide arms 103 and the output coupling 106 is fastened to at least three secondary guide arms 105. The primary guide arms 103 and the secondary guide arms are connected by the connecting arms 104 by pins 109, bearings 110 and retaining rings 108 externally. Further, the rotary motion is transmitted from the input shaft 101 to the input coupling 102, from the input coupling 102 to the primary guide arms 103, from the primary guide arms 103 to the connecting arms 104, from the connecting arms 104 to the secondary guide arms 105, from the secondary guide arms 105 to the output coupling 106 and finally to the output shaft 107.

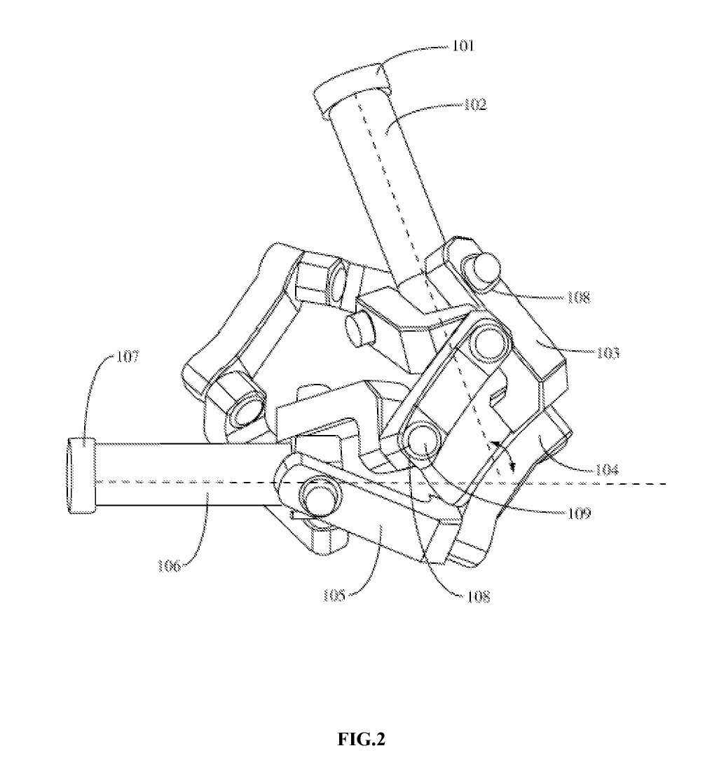

FIG. 2 illustrates an isometric view of the constant speed universal mechanical joint and its components at 130 degree crossover angle according to an embodiment herein. According to an embodiment, the components of the mechanical universal joint are at a crossover angle of 135 degree. The embodiment comprises of an input shaft 101, an input coupling 102, an output shaft 107, an output coupling 106, at least three primary guide arms 103, at least three secondary guide arms 105, at least three connecting arms 104, at least six pins 109, at least eighteen retaining ring externally 108 and at least twelve bushes or bearings 110, wherein the rotary motion is transmitted from the input shaft 101 to the input coupling 102, the primary guide arms 103, the connecting arms 104, secondary guide arms 105, to the output coupling 106 and finally to output shaft 107.

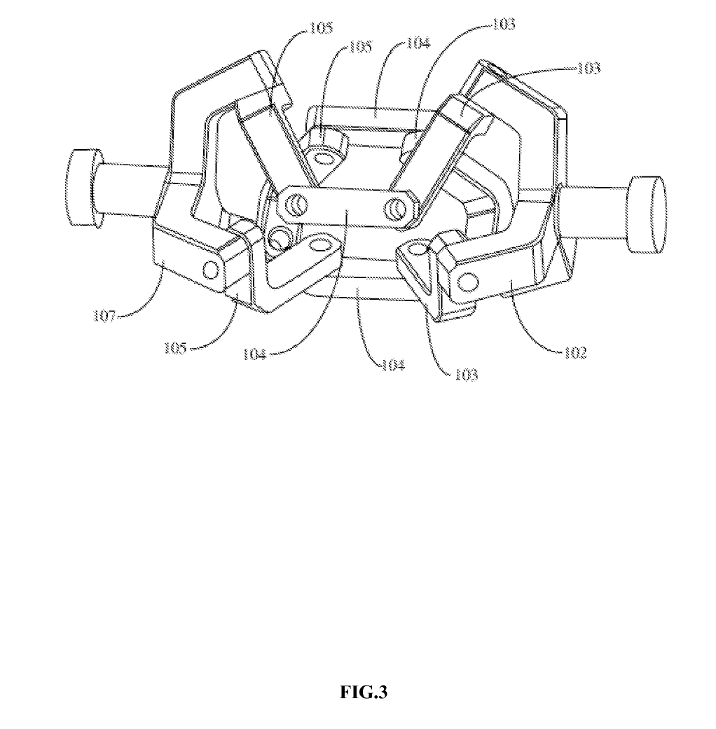

FIG. 3 illustrates an isometric view of the constant speed universal mechanical joint used between two shafts according to an embodiment herein. The embodiment comprises of eleven components with at least five cylindrical components and nine revolute joints. The embodiment comprises of an input shaft 101, an input coupling 102, an output shaft 107, an output coupling 106, at least three primary guide arms 103, at least three secondary guide arms 105, at least three connecting arms 104, at least six pins 109, at least eighteen retaining ring externally 108 and at least twelve bushes or bearings 110, wherein the input coupling 102 and the output coupling 106 is fastened to at least three primary guide arms 103 and three secondary guide arms 105 by using at least three retaining rings externally 108. Further each of the primary guide arms 103 and the secondary guide arms 105 is linked to the connecting arms 104 by the pins 109, the bearings 110 and the retaining rings externally 108. The rotary motion is transmitted from the input shaft 101, to the input coupling 102, from the input coupling 102 to the primary guide arms 103, from the primary guide arms 103 to the connecting arms 104, from the connecting arms 104 to the secondary guide arms 105, from the secondary guide arms 105 to output coupling 106 and finally to output shaft 107 thereby transmitting constant velocity from the input shaft 101 to the output shaft 102 at high crossover angles up to 135 degrees.

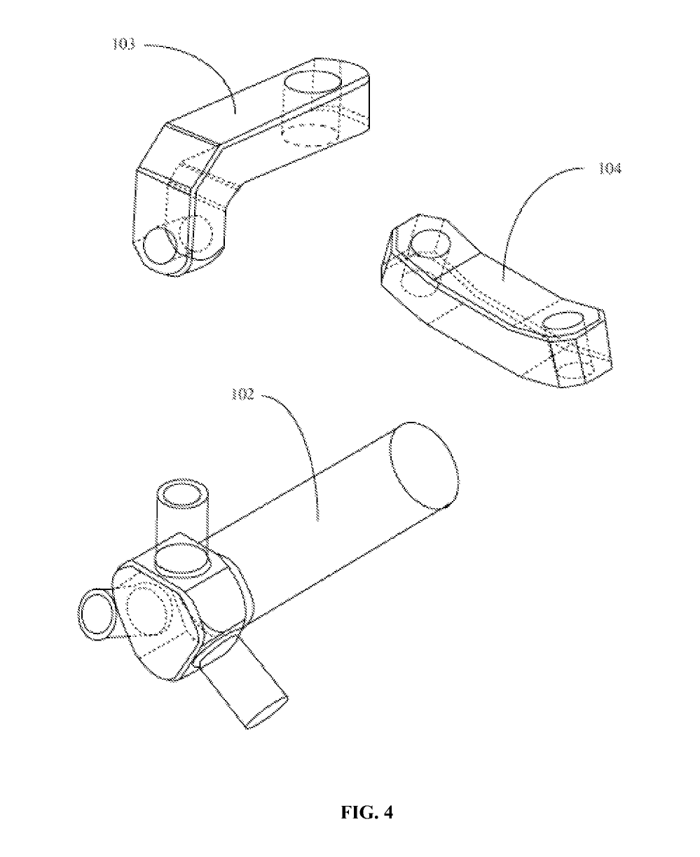

FIG. 4 illustrates an exploded view of the primary components used in the fabrication mechanism of the constant speed universal mechanical joint according to an embodiment herein. The embodiment shows the guide arms which are used as the primary guide arm 103 and the secondary guide arm 105. The primary guide arm 103 and the secondary guide arm 105 are connected to the input coupling 102 and the output coupling 106 at one end. Further, the primary guide arm 103 and the secondary guide arm 105 are connected by a connecting arm 104. The primary guide arm 103, the secondary guide arm 105, the connector arm 104, the input coupling 102 and the output coupling 106 are connected to each other through bushes or bearings 110.

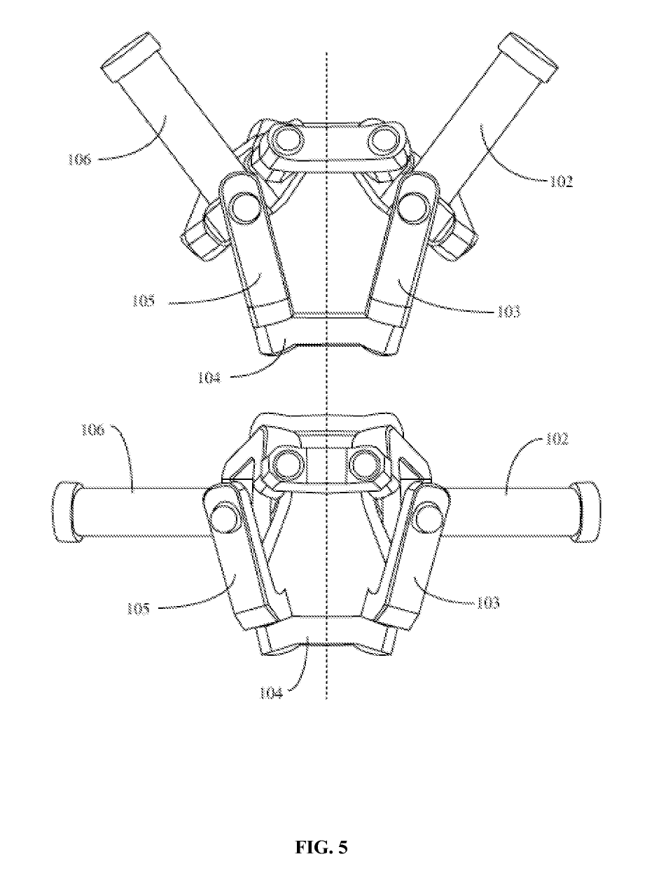

FIG. 5 illustrates a perspective view of the constant speed universal mechanical joint such that the symmetry is preserved in the plane at all angles according to an embodiment herein. The universal cross joint includes at least three connecting arms 104, at least three primary guide arms 103 and at least three secondary guide arms 105 to balance the symmetry of the universal mechanical joint and to preserve the symmetry in the plane for all the angles that may arise with the constant angular velocity ratio. The addition of at least three connecting arms 104, at least three primary guide arms 103 and at least three secondary guide arms 105 enable the universal mechanical joint mechanism to preserve the symmetry on the plane and provide constant speed at a crossover angle of 135 degrees and more. The embodiment has fourteen joints in which five joints are of cylindrical joints and other are of revolute joints. These joints are created by the combination of pins 109, bushes or bearings 110 and retaining rings 108 externally.

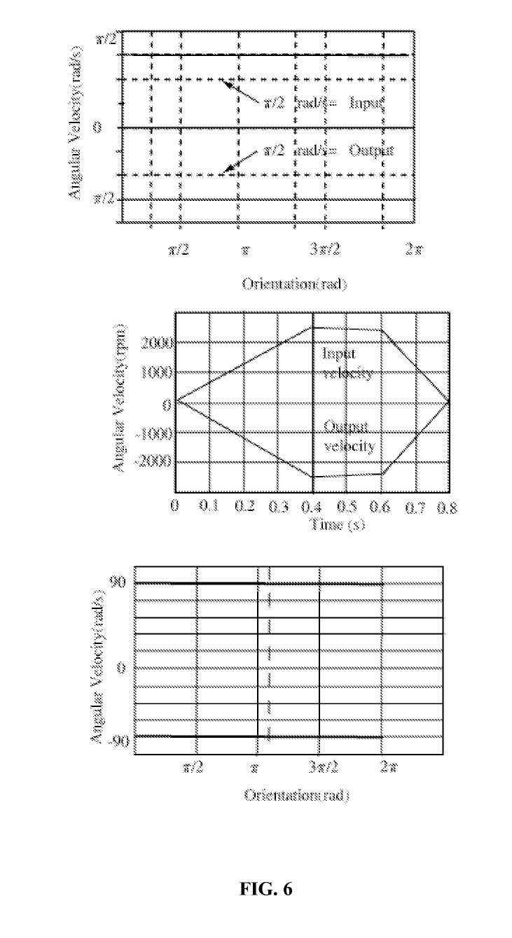

FIG. 6 illustrates a graphical output of the simulation software used in measuring the angular velocity at different orientation of the constant speed universal mechanical joint according to an embodiment herein. According to an embodiment, various simulation softwares such as COSMOS Motion, Visual Nastran, and Autodesk Inventor are used in carrying out simulations on measuring the angular velocity at different orientation of the constant speed universal mechanical joint. The figures show the simulation outputs with variable velocity of f(x) and at steady velocity of π/2 rad/s at 130 crossover angle. The output value is negative because of the positions of the input and output axis in the Cartesian coordinates which are reversed in simulation.

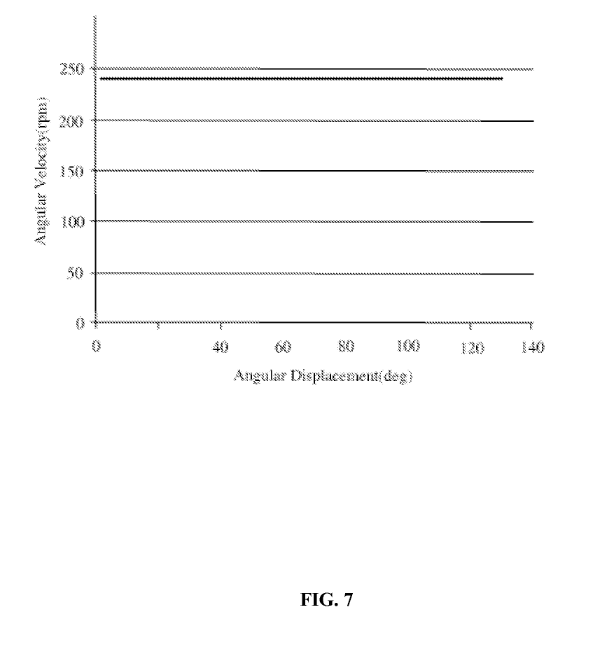

FIG. 7 illustrates a graphical output of the simulation software used in measuring the angular velocity of the constant speed universal mechanical joint according to an embodiment herein. According to the embodiment herein, at least three connecting arms 104, at least three primary guide arms 103 and at least three secondary guide arms 105 as shown in FIG. 5 are used to balance the symmetry of the universal mechanical joint and to preserve the symmetry in the plane for all the angles that may arise with the constant angular velocity ratio. The addition of at least three connecting arms 104, at least three primary guide arms 103 and at least three secondary guide arms 105 enable the universal mechanical joint mechanism to preserve the symmetry on the plane and to provide constant speed at a crossover angle of 135 degrees and more. After the fabrication process, the constant speed universal mechanical joint was evaluated at 240 rpm (rounds per minute) and at crossover angles from 0 to 135 degrees and vice versa. The output speed data was recorded by speedometer sensor and was transferred to a computer and then the results were drawn. The graphical output shows the output angular velocity at all angles is constant and equal to input angular velocity.

The universal mechanical joint according to the embodiments herein provides constant angular velocity ratio during rotation at high angular displacements. The constant speed universal mechanical joint can be used between two shafts with crossover angles up to 135 degrees and more. The constant speed universal mechanical joint is dynamically balanced and occupies optimum working space. Further, the velocity ratio of the constant speed universal mechanical joint herein is constant for all crossover angles between the two shafts thereby making the universal mechanical joint suitable for use in vehicles which needs a higher range of adjustment of height in lands with a slope and reducing the turning radius in machineries which needs high angular displacement at constant speed.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the embodiments herein with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A universal mechanical joint mechanism comprising:
an input coupling;
an output coupling;
at least one input shaft;
at least one output shaft;
a plurality of guide arms;
at least three connecting arms;
a plurality of connecting means;
a plurality of retaining rings; and
a plurality of bearings;
Wherein the input coupling is connected to the input shaft and the output coupling is connected to the output shaft in such a way that the plurality of retaining rings joins each of the input coupling and the output coupling through the plurality of guide arms and the plurality of connecting means and wherein the plurality of retaining rings and the plurality of bearings are provided to connect each of the plurality of guide arms to the at least three connecting arms.

2. The universal mechanical joint mechanism according to claim 1, wherein the plurality of guide arms includes at least three primary guide arms.

3. The universal mechanical joint mechanism according to claim 1, wherein the plurality of guide arms includes at least three secondary guide arms.

4. The universal joint mechanism according to claim 1, wherein the plurality of guide arms include at least two openings to join at least one of the input coupling, output coupling and one of the at least three connecting arms.

5. The universal joint mechanism according to claim 1, wherein the plurality of guide arms is at least one of a L shaped structure or C-shaped structure.

6. The universal mechanical joint mechanism according to claim 1, wherein the input coupling includes at least three Y shaped branches.

7. The universal mechanical joint mechanism according to claim 6, wherein the angle between the each of the at least three Y shaped branches is 120 degrees.

8. The universal mechanical joint mechanism according to claim 6, wherein at least three Y shaped branches is straight angled, C-shaped or a sector of sphere.

9. The universal mechanical joint mechanism according to claim 1, wherein at least one primary guide arm, at least one secondary guide arm and at least one connecting arm is connected to at least one branch of the input coupling.

10. The universal mechanical joint mechanism according to claim 1, wherein the output coupling includes at least three Y shaped branches.

11. The universal mechanical joint mechanism according to claim 10, wherein the angle between the each of the at least three Y shaped branches is 120 degrees.

12. The universal mechanical joint mechanism according to claim 10, wherein at least three Y shaped branches is of a straight angled, C-shape or a sector of sphere.

13. The universal mechanical joint mechanism according to claim 1, wherein at least one primary guide arm, at least one secondary guide arm and at least one connecting arm is connected to at least one branch of the output coupling.

14. The universal mechanical joint mechanism according to claim 1, wherein the at least three connecting arms include one of a straight, angled, curved, triangular or a sector of sphere shape.

15. The universal mechanical joint mechanism according to claim 1, further comprises of at least five cylindrical joints and at least nine revolute joints fastened to the plurality of guide arms.

16. The universal mechanical joint mechanism according to claim 1, wherein the mechanism is adapted to transmit constant velocity at all crossover angles up to 135 degrees.
